(19) United States
(12) Patent Application Publication
(10) Pub. No.: US 2026/0252700 A1
(43) Pub. Date: Aug. 27, 2026

(54) DICE IMPLEMENTATION

(71) Applicant: Micron Technology, Inc., Boise, ID (US)

(72) Inventor: Zhan Liu, Cupertino, CA (US)

(21) Appl. No.: 19/544,789

(22) Filed: Feb. 19, 2026

Related U.S. Application Data
(60) Provisional application No. 63/762,920, filed on Feb. 25, 2025.

(51) Int. Cl. G06F 21/57; H04L 9/08

(52) U.S. Cl. CPC G06F 21/575; H04L 9/0866; G06F 2221/033

(57) ABSTRACT

A computing device for secure booting of a layered software architecture includes a hardware processor and memory storing multiple software layers. Each layer generates a cryptographic key from a device secret and code measurements. This key decrypts a parameter for the next layer, which then boots using the decrypted parameter. If the parameter is incorrect, the next layer will not load. The cryptographic key can be symmetric or asymmetric, and the parameter may include an initialization function, cryptographic key, or configuration data. Code measurements are cryptographic hashes.

### PRIORITY APPLICATION

This application claims the benefit of priority to U.S. Provisional Application Ser. No. 63/762,920, filed Feb. 25, 2025, which is incorporated herein by reference in its entirety.

### TECHNICAL FIELD

Embodiments pertain to secure booting and device identity in layered software architectures. Some embodiments relate to methods and systems for ensuring the integrity of each software layer by using cryptographic keys derived from measurements of the current layer's code and a unique device secret.

### BACKGROUND

In today's interconnected world, the security of embedded systems and Internet of Things (IoT) devices has become important. As these devices proliferate and handle increasingly sensitive data, they face significant challenges in maintaining robust security measures. One of the fundamental issues is the protection of cryptographic keys and device identities. Traditional systems often store these crucial elements in fuse-banks or non-volatile memory, leaving them vulnerable to compromise if the code running on the system-on-chip (SoC) is breached. This vulnerability can lead to irrevocable key disclosure, potentially compromising the entire security infrastructure of a device or network.

Furthermore, the complexity of modern Trusted Execution Environments (TEEs), which can contain tens or hundreds of thousands of lines of code, introduces an expansive attack surface. This complexity makes it challenging to ensure that only authorized code has access to sensitive cryptographic material, thereby increasing the risk of security breaches. Additionally, the management of device identities and the secure execution of firmware updates present ongoing challenges, particularly in resource-constrained environments typical of many IoT and embedded systems.

These security concerns are compounded by the need for a delicate balance between robust security measures and practical device manageability. Implementing stringent security protocols can often complicate routine operations such as firmware updates or device provisioning, potentially hindering the deployment and maintenance of large-scale IoT networks.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a logical diagram of a modified Device Identifier Composition Engine (DICE) implementation where each layer encrypts a parameter of the next layer to use in subsequent boot cycles according to some examples of the present disclosure.

FIG. 2 shows a logical diagram illustrating the subsequent boot process of a device after the initial setup described in FIG. 1 according to some examples of the present disclosure.

FIG. 3 shows a flowchart of a method of ensuring that each layer has been uncompromised by using the measurement of a current layer to load the next layer according to some examples of the present disclosure.

FIG. 4 shows a logical diagram of software layers of a device and a logical diagram of each layer according to some examples of the present disclosure.

FIG. 5 illustrates an example of an environment including a discrete computing device in the form of a host device and a memory device configured to communicate over a communication interface according to some examples of the present disclosure.

FIG. 6 illustrates a block diagram of an example machine upon which any one or more of the techniques discussed herein may be performed according to some examples of the present disclosure.

### DETAILED DESCRIPTION

Device Identifier Composition Engine (DICE) is a security standard promulgated by the Trusted Computing Group (TCG) that attempts to solve the problems described above while keeping complexity to a minimum. DICE aims to protect the cryptographic key of devices, provide mechanisms for updating one or more of the keys in case they are compromised, and to provide for remote attestation of the device software.

DICE accomplishes this goal by having a protected device secret only accessible by very secure and low layer code. This low layer code then uses the measurement of the low layer code and the device secret to create a device key pair. The device key pair may then be used to identify the computing device to other computing devices. The low layer code then uses the device secret, and a measurement of the firmware to create an alias key pair. The alias key pair may then be extended by the firmware to create another key pair for a higher software layer (e.g., an operating system, other applications, and the like) using the alias key pair and a measurement of the higher software layer. This key extension process may be repeated for other software layers with each successive layer extending the key of the previous layer. Each layer is charged with protecting its own keypair. Since each layer has its own key that depends on its own measurements, if a key is compromised, or the software in the layer changes, the device will create new keys for that layer and trust can then be restored. DICE may also generate one or more certificates that may be signed by the device manufacturer. This may allow other relying devices to trust the keys given by the device.

As can be appreciated from the above description, the keys in various DICE layers are generated based upon the keys of the previous layer (or the device secret for the lowest layer) and measurements of software images. If the measurements of the software images change, the keys will change. While the key chaining of the DICE protocol may alert other devices to a change in software on the device (because the key changes), there is no way for either the device itself, or another device to verify that the firmware objects loaded are authorized. For example, the key may change because of an authorized and legitimate firmware update; or the key may change because of an unauthorized and illegitimate firmware update. So, while the relying device may recognize the key change, these devices may have no way of knowing whether the updated key is legitimate.

Past solutions to this problem either utilized a remote attestation server to authenticate keys so that the other entities could verify the software on the device or utilized local write protected areas that store measurements of authentic firmware. These solutions require a network connection and more complicated hardware that included the local write protected areas and additional complexity.

Disclosed in some examples are methods, systems, devices, and machine-readable mediums which provide a simplified and self-contained approach to implementing secure boot and device identity in layered architectures. The technical solution involves encrypting and storing one or more parameters needed for boot of a next software layer in the software stack using a symmetric key derived from the Compound Device Identity (CDI) (or Unique Device Secret for the hardware layer) of the current layer and the Trusted Computing Base Component Identifier (TCI) (e.g., measurement) of the next layer. Upon boot up, each layer decrypts the boot parameters of the next layer and uses those boot parameters to launch the next layer. If the current layer is compromised, the generated key will not be able to unlock the important parameters and the current layer will not be able to execute further code.

More specifically, during setup or after an authorized firmware update, the hardware layer uses a unique device secret (UDS) and a Trusted Computing Base Component Identifier (TCI) (e.g., a measurement of the code of the next layer) for Layer 0 to generate a key(0) which is used for encrypting parameters for boot layer 0. Layer 0 may use the Compound Device Identifier for layer 0 and the TCI for layer 1 to generate a key(1) which is used to encrypt parameters which will be used to boot layer 1 and so on. The various keys generated will be discarded once the parameters are encrypted.

During normal boot-up, the hardware layer measures layer 0 code and generates TCI layer 0 again. The hardware layer uses the UDS and TCI for layer 0 to generate key(0) again. If layer 0 is not compromised, key(0) will be the same as those generated during setup and the decrypted parameters will be correct and layer 0 will be loaded correctly. If the key(0) is not the same, layer 0 will not load. At the same, CDI0 is also calculated as a normal DICE device will do. After successfully boot to layer 0, the key(0) should be discarded for security reasons. When layer 0 attempts to load layer 1, layer 0 calculates TCI for layer 1, uses the Compound Device Identity (CDI) for layer 0 and TCI for layer 1 to generate key(1) again. If layer 1 is not compromised, both TCI for layer 1 and key(1) will be the same as those calculated during setup, therefore, parameters will be decrypted correctly and the layer 1 will be successfully loaded. If layer 1 is compromised, then key(1) will be different and decrypt of the parameters will fail and so loading of layer 1 will fail.

In some examples, to make the CDI generation independent of the key used to encrypt the boot parameters of a layer, different key generation or one-way functions may be used to generate the CDI and the encryption key.

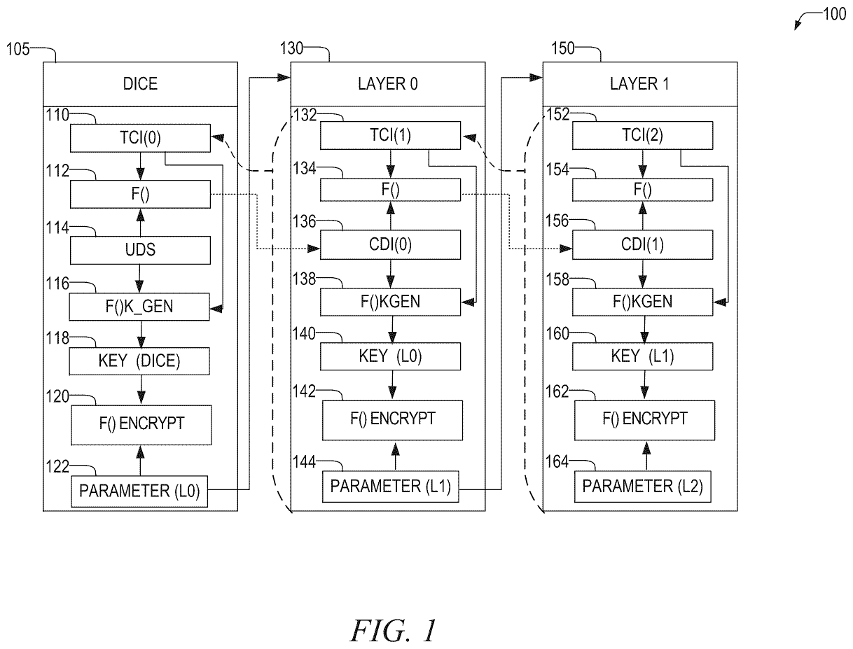

FIG. 1 illustrates a logical diagram 100 of a modified Device Identifier Composition Engine (DICE) implementation where each layer encrypts a parameter of the next layer to use in subsequent boot cycles. FIG. 1 illustrates a setup process during initial boot or upon a subsequent software update to one or more of the layers. The diagram begins with a DICE layer 105. The DICE layer 105 calculates a Trusted Computing Base (TCB) Component Identifier (TCI) for Layer 0 110. The TCI is a measurement of the next layer, including configuration and version information. In some examples, the TCI is a hash of the next layer's (in this case layer 0's) executable code. The TCI for layer 0 110 along with a Unique Device Secret (UDS) as input into a one-way function 112. The output of the one-way function 112 is a Compound Device Identity (CDI) which is passed to the next layer. The UDS 114 may also be used as input to a key generation function 116, along with the TCI of layer 0 to produce a cryptographic key 118 (either an asymmetric or symmetric key) which is then input to an encryption algorithm 120 and used to encrypt parameters of layer 0 122 such as configuration data or initialization functions. The encrypted parameter is stored in non-volatile storage for later use.

Layer 0 130 calculates a TCI for Layer 1 132, which is a measurement of layer 1's code. The measurement may be generated by a hash function. The TCI for layer 1 132 is input into a one way function 134, along with the CDI for layer 0 136 to create a CDI for layer 1 156. The CDI for Layer 0 136 is also used as input to a key generation function 138 along with the TCI for layer 1 132 to produce a layer 0 cryptographic key 140 (either a symmetrical or asymmetrical key). This key is then used as input into an encryption algorithm 142 along with a parameter from layer 1 144 to encrypt the parameters of layer 1 150. This encrypted parameter may be stored in non-volatile storage for later use.

Layer 1 150 calculates a TCI for Layer 2 152 (layer 2 is not shown), which is a measurement of layer 2's code which is generated by a hash. This hash and CDI for layer 1 156 is then processed by a one way function 154 to produce a CDI for Layer 2 (not shown). CDI for layer 1 156 is also used as input, along with the TCI for layer 2 152 to a key generation function 158 to produce a layer 1 key 160 (which may be symmetrical or asymmetrical). The layer 1 key 160 is used by an encryption function 162 to encrypt a Layer 2 parameter 164. The encrypted parameter is stored for use during the boot process of Layer 2.

In some examples, the parameters 122, 144, and 164 used may be a parameter passed to the next layer's entry function (e.g., the function that the code first runs). That is, the layer 1 150 then executes and checks the value of the parameter against an expected value or parameter. If the value passed by layer 0 130 is not the expected value or parameter, the function terminates without performing additional actions and layer 1 150 terminates. If the value passed by layer 0 130 is the expected value or parameter, the function continues executing and layer 1 150 continues execution. The expected value may be a random value, or some other value communicated to each layer by the proceeding layer during setup of FIG. 1, or during manufacturing.

In other examples, the parameters 122, 144, and 164 may include cryptographic keys, configuration data, or initialization functions. For instance, the parameter could be a symmetric key used for encrypting and decrypting data within the next layer. If the current layer is compromised, the generated key will be incorrect, and the decryption of the next layer's data will fail, preventing the next layer from executing as it is missing the cryptographic key.

In yet additional examples, the parameters may include configuration data that specifies how the next layer should be initialized. This configuration data could include memory addresses, hardware settings, or other critical initialization parameters. If the current layer is compromised, the incorrect configuration data will be used, causing the next layer to fail during initialization.

In still other examples, the parameter may be an initialization function, which is a piece of code that must be executed to properly set up the next layer. This function could perform tasks such as setting up hardware interfaces, initializing memory, or performing security checks. If the current layer is compromised, the initialization function will be incorrect or missing, causing the next layer to fail during its setup process.

In still yet additional examples, the parameter may be the code, or a portion of the code (e.g., the initialization function) for the next layer itself. Without the cryptographic key, the code for the next layer may not be decrypted and may not be executable.

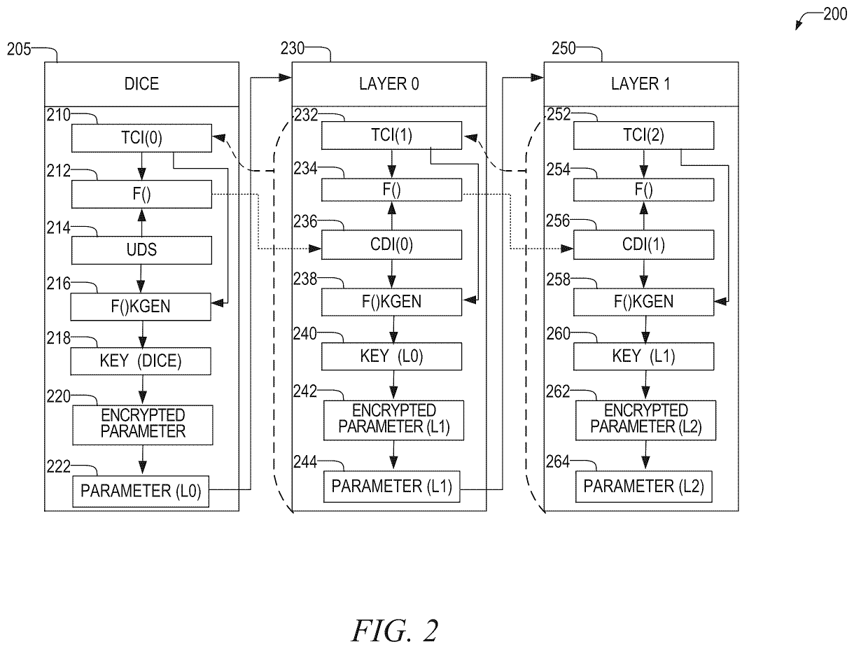

FIG. 2 shows a logical diagram 200 illustrating the subsequent boot process of a device after the initial setup described in FIG. 1. The diagram includes three main sections: DICE Layer 205, Layer 0 230, and Layer 1 250. Each section demonstrates the decryption and utilization of parameters to launch the next layer in the boot sequence.

The DICE Layer 205 begins with calculating a Trusted Computing Base (TCB) Component Identifier (TCI) for Layer 0 210. The TCI for Layer 0 210 is a measurement of the next layer, which includes configuration and version information. The TCI for Layer 0 210 is processed along with the UDS 214 by a one-way function 212 to produce a Compound Device Identifier (CDI). The Device Secret (UDS) 214 is used, along with the TCI for Layer 0 210 as input to a generation function 216 to produce a cryptographic key 218. This cryptographic key 218 is then used to decrypt the encrypted parameter 220, resulting in the Layer 0 Parameter 222, which is used to boot Layer 0 230.

Layer 0 230 includes a TCI for Layer 1 232, which is a measurement of Layer 1's code generated by a hash. The TCI for Layer 1 232 is processed along with the CDI for layer 0 236 by a one-way function 234 to create a CDI for Layer 1 256. The CDI for Layer 0 236 is used as input, along with the TCI for layer 1 232 to a key generation function 238 to produce a Layer 0 cryptographic key 240. This cryptographic key 240 is then used to decrypt the encrypted parameter 242, resulting in the Layer 1 Parameter 244, which is used to boot Layer 1 250.

Layer 1 250 includes a TCI for Layer 2 252, which is a measurement of Layer 2's code generated by a hash. The TCI for Layer 2 252 is processed by a one-way function 254 along with the CDI for layer 1 256 to produce a CDI for Layer 2 (not shown). The CDI for Layer 1 256 is used, along with the TCI for Layer 2 252, as input to a generation function 258 to produce a Layer 1 cryptographic key 260. This cryptographic key 260 is then used to decrypt the encrypted parameter 262, resulting in the Layer 2 Parameter 264, which is used to boot the subsequent layer (not shown in the figure).

The process illustrated in FIG. 2 ensures that each layer in the boot sequence only executes if the integrity of the previous layer is intact. If any layer is compromised, the generated key will be incorrect, and the decryption of the next layer's parameter will fail, preventing the compromised layer from executing further code.

While FIGS. 1 and 2 illustrate the process with three layers, it should be understood by those skilled in the art that the principles and methods described herein are scalable and can be extended to any number of layers. Each additional layer would follow the same process of generating a Trusted Computing Base (TCB) Component Identifier (TCI), processing it through a one-way function to produce a Compound Device Identifier (CDI), and using the CDI to generate a cryptographic key. This key would then be used to decrypt the parameters necessary for booting the subsequent layer. The integrity and security of each layer are thus cryptographically bound to the previous layer, ensuring a robust and scalable secure boot process.

The proposed solution offers several benefits over existing methods. For example, it eliminates the need for a remote attestation server and local write-protected areas (as the parameters are encrypted and modifying them would cause boot failure), simplifying the implementation and reducing hardware complexity. Second, it does not require a network connection, making the system more standalone and resilient to network-related issues. Third, the method provides a new way to verify that all layers from 0 to n are uncompromised, ensuring the integrity of the entire boot process without the need for explicit checks at each stage. Additionally, the solution is versatile and can be applied to various types of parameters, including cryptographic keys, configuration data, and initialization functions. For example, the parameter could be a symmetric key used for encrypting and decrypting data within the next layer. If the current layer is compromised, the generated key will be incorrect, and the decryption of the next layer's data will fail, preventing the next layer from executing. Similarly, the parameter could be configuration data specifying how the next layer should be initialized, or an initialization function that must be executed to set up the next layer. In each case, if the current layer is compromised, the incorrect parameter will cause the next layer to fail during execution.

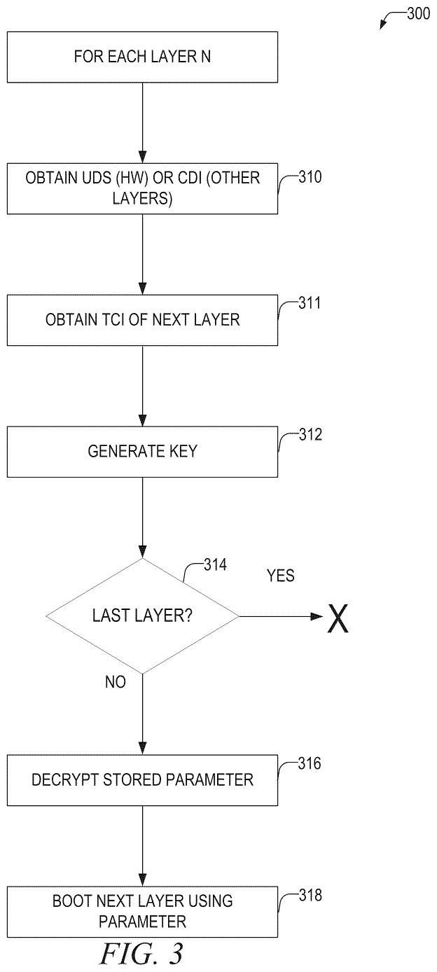

FIG. 3 shows a flowchart of a method 300 of ensuring that each layer has been uncompromised by using the measurement of a current layer to load the next layer according to some examples of the present disclosure. The method 300 is executed for one or more software layers of a device. That is, the method 300 applies for one or more layers in the system, starting from the initial layer and proceeding to subsequent layers.

At operation 310, the method retrieves either the UDS (for the hardware layer) or the Compound Device Identifier (CDI) for the current layer. The CDI is derived from the device secret and the measurement of the current layer's code. This measurement ensures that any changes in the layer's code will result in a different CDI. At operation 311, the method obtains the TCI of the next layer. For example, by measuring a hash of the next layer.

Next, at operation 312, the method generates a cryptographic key using the obtained CDI and TCI. This key can be either a symmetric key or an asymmetric key, depending on the implementation. The generated key is specific to the current layer and is used to secure the parameters of the next layer. The method then proceeds to the decision operation 314 where the system checks whether the current layer is the last layer in the sequence. If the current layer is the last layer, the method terminates. If the current layer is not the last layer, the method continues to the next operation.

At operation 316, the method uses the generated cryptographic key to decrypt the stored parameter of the next layer. This parameter can include configuration data, initialization functions, or other information required to boot the next layer. At operation 318, the method uses the decrypted parameter to boot or load the next layer. If the decrypted parameter is incorrect due to a compromised current layer, the next layer will fail to boot, ensuring that the system does not proceed with compromised code.

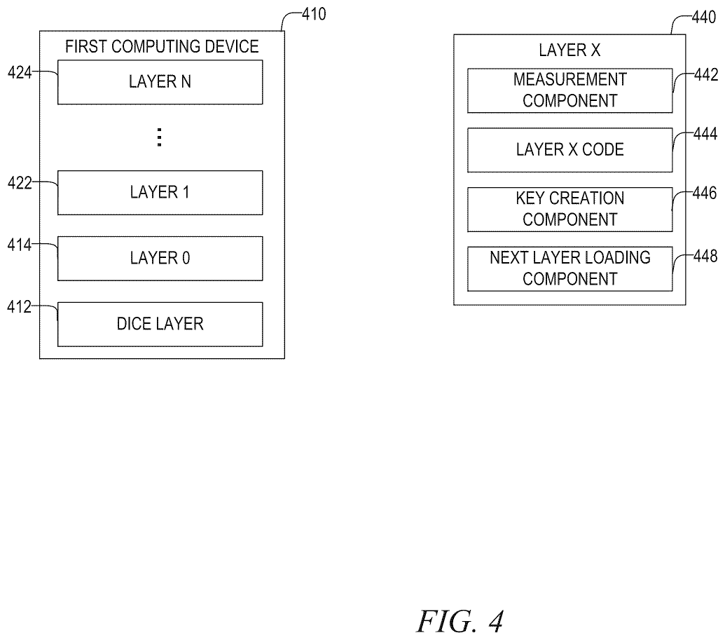

FIG. 4 shows a logical diagram of software layers of a device and a logical diagram of each layer according to some examples of the present disclosure. The first computing device 410 includes a DICE layer 412, a layer 0 414, a layer 1 422, zero or more layers between layer 1 and layer N, and a layer N 424. The DICE layer 412 is responsible for the initial secure boot process and the generation of cryptographic data based on the device's secret and measurements of the code. The layer 0 414 follows the DICE layer 412 and uses the cryptographic data generated by the DICE layer 412 to decrypt the parameters and boot layer 0 414. The layer 1 422 follows the same process, using the data generated by the layer 0 414 to decrypt the parameters and boot the next layer, and so on, up to layer N 424, ensuring that each layer's integrity is verified before booting the next layer.

The layer X 440 illustrates an example logical diagram of one or more of the layers 412-424. Layer X 440 includes a measurement component 442, layer X code 444, a key creation component 446, and a next layer loading component 448. The measurement component 442 measures the code of the next layer to generate the TCI for use in generating the CDI for the next layer and for generating the key to unlock the boot parameters of the next layer. The layer X code 444 represents the executable code for the current layer. The key creation component 446 generates a cryptographic key based on the measurement of the next layer's code and the CDI of the present layer. The next layer loading component 448 uses the generated cryptographic code to decrypt the parameters of the next layer and boot the next layer. This ensures that if any layer is compromised, the incorrect code will prevent the next layer from booting, maintaining the security of the device.

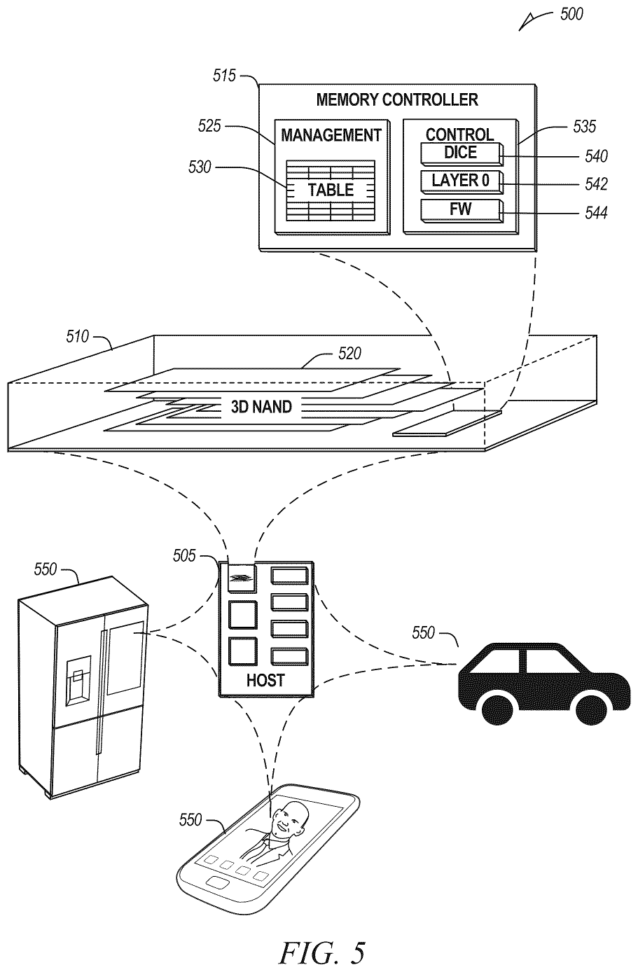

The presently described examples may be used in a variety of computing devices and there components, for example, a memory device, which may be integrated into a variety of other devices. FIG. 5 illustrates an example of an environment 500 including a discrete computing device in the form of a host device 505 and a memory device 510 configured to communicate over a communication interface. The host device 505 or the memory device 510 may be included in a variety of products 550, such as Internet of Things (IoT) devices (e.g., a refrigerator or other appliance, sensor, motor or actuator, mobile communication device, automobile, drone, etc.) to support processing, communications, or control of the product 550. The layers shown and discussed in FIGS. 1-4 may be incorporated within one or more components of one or more of the devices shown in FIG. 5 including one or more memory devices.

The memory device 510 includes a memory controller 515 and a memory array 520 including, for example, a number of individual memory die (e.g., a stack of three-dimensional (3D) NAND die). In 3D architecture semiconductor memory technology, vertical structures are stacked, increasing the number of tiers, physical pages, and accordingly, the density of a memory device (e.g., a storage device). In an example, the memory device 510 can be a discrete memory or storage device component of the host device 505. In other examples, the memory device 510 can be a portion of an integrated circuit (e.g., system on a chip (SOC), etc.), stacked or otherwise included with one or more other components of the host device 505.

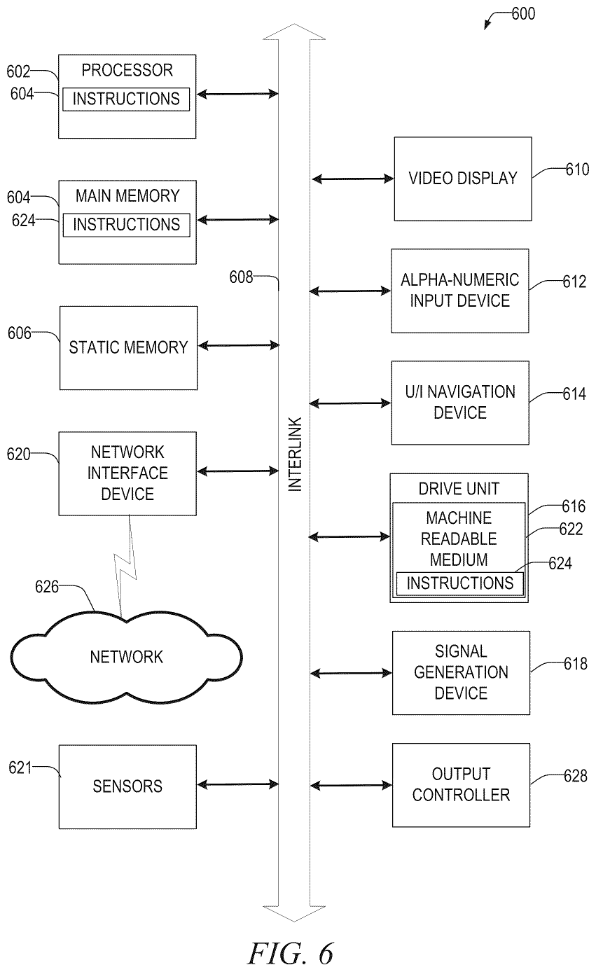

One or more communication interfaces can be used to transfer data between the memory device 510 and one or more other components of the host device 505, such as a Serial Advanced Technology Attachment (SATA) interface, a Peripheral Component Interconnect Express (PCIe) interface, a CXL interface, a Universal Serial Bus (USB) interface, a Universal Flash Storage (UFS) interface, an eMMC™ interface, or one or more other connectors or interfaces. The host device 505 can include a host system, an electronic device, a processor, a memory card reader, or one or more other electronic devices external to the memory device 510. In some examples, the host device 505 may be a machine having some portion, or all, of the components discussed in reference to the machine 600 of FIG. 6.

The memory controller 515 can receive instructions from the host device 505, and can communicate with the memory array, such as to transfer data to (e.g., write or erase) or from (e.g., read) one or more of the memory cells, planes, sub-blocks, blocks, or pages of the memory array. The memory controller 515 can include, among other things, circuitry, or firmware, including one or more components or integrated circuits. For example, the memory controller 515 can include one or more memory control units, circuits, or components configured to control access across the memory array 520 and to provide a translation layer between the host device 505 and the memory device 510. The memory controller 515 can include one or more input/output (I/O) circuits, lines, or interfaces to transfer data to or from the memory array 520. The memory controller 515 can include a memory manager 525 and an array controller 535.

The memory manager 525 can include, among other things, circuitry, or firmware, such as a number of components or integrated circuits associated with various memory management functions. For purposes of the present description example memory operation and management functions will be described in the context of NAND memory. Persons skilled in the art will recognize that other forms of non-volatile memory may have analogous memory operations or management functions. Such NAND management functions include wear leveling (e.g., garbage collection or reclamation), error detection or correction, block retirement, or one or more other memory management functions. The memory manager 525 can parse or format host commands (e.g., commands received from a host) into device commands (e.g., commands associated with operation of a memory array, etc.), or generate device commands (e.g., to accomplish various memory management functions) for the array controller 535 or one or more other components of the memory device 510.

The memory manager 525 can include a set of management tables 530 configured to maintain various information associated with one or more component of the memory device 510 (e.g., various information associated with a memory array or one or more memory cells coupled to the memory controller 515). For example, the management tables 530 can include information regarding block age, block erase count, error history, or one or more error counts (e.g., a write operation error count, a read bit error count, a read operation error count, an erase error count, etc.) for one or more blocks of memory cells coupled to the memory controller 515. In certain examples, if the number of detected errors for one or more of the error counts is above a threshold, the bit error can be referred to as an uncorrectable bit error. The management tables 530 can maintain a count of correctable or uncorrectable bit errors, among other things.

The array controller 535 can include, among other things, circuitry or components configured to control memory operations associated with writing data to, reading data from, or erasing one or more memory cells of the memory device 510 coupled to the memory controller 515. The memory operations can be based on, for example, host commands received from the host device 505, or internally generated by the memory manager 525 (e.g., in association with wear leveling, error detection or correction, etc.).

The array controller 535 can include a DICE component 540, which can include, among other things, implement the functions and logic of DICE layer. Layer zero 542 may implement the functions and logic of layer zero. Similarly, the firmware 544 may implement one or more other layers.

In some examples, the memory array may comprise a number of NAND dies and one or more functions of the memory controller 515 for a particular NAND die may be implemented on an on-die controller on that particular die. Other organizations and delineations of control functionality may also be utilized, such as a controller for each die, plane, superblock, block, page, and the like.

The memory array 520 can include several memory cells arranged in, for example, a number of devices, semi-conductor dies, planes, sub-blocks, blocks, or pages. As one example, a 48 GB TLC NAND memory device can include 18,592 bytes (B) of data per page (16,384+2208 bytes), 1536 pages per block, 548 blocks per plane, and 4 or more planes per device. As another example, a 32 GB MLC memory device (storing two bits of data per cell (i.e., 4 programmable states)) can include 18,592 bytes (B) of data per page (16,384+2208 bytes), 1024 pages per block, 548 blocks per plane, and 4 planes per device, but with half the required write time and twice the program/erase (P/E) cycles as a corresponding TLC memory device. Other examples can include other numbers or arrangements. In some examples, a memory device, or a portion thereof, may be selectively operated in SLC mode, or in a desired MLC mode (such as TLC, QLC, etc.).

In operation, data is typically written to or read from the NAND memory device 510 in pages and erased in blocks. However, one or more memory operations (e.g., read, write, erase, etc.) can be performed on larger or smaller groups of memory cells, as desired. The data transfer size of a NAND memory device 510 is typically referred to as a page, whereas the data transfer size of a host is typically referred to as a sector.

Although a page of data can include a number of bytes of user data (e.g., a data payload including a number of sectors of data) and its corresponding metadata, the size of the page often refers only to the number of bytes used to store the user data. As an example, a page of data having a page size of 4 KB may include 4 KB of user data (e.g., 8 sectors assuming a sector size of 512 B) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays 520 can provide for different page sizes or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code data than a memory device with a lower bit error rate). As an example, a multi-level cell (MLC) NAND flash device may have a higher bit error rate than a corresponding single-level cell (SLC) NAND flash device. As such, the MLC device may require more metadata bytes for error data than the corresponding SLC device.

While FIG. 5 illustrated the operation of the present disclosure in the context of a memory device, in other examples other devices may incorporate the techniques disclosed herein. For example, network interfaces, graphics cards, Random Access Memory (RAM), hard disk drives, and the like.

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be in the form of a host device (such as host device 505), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 600 may include one or more hardware processors, such as processor 602. Processor 602 may be a central processing unit (CPU), a graphics processing unit (GPU), a hardware processor core, or any combination thereof. Machine 600 may include a main memory 604 and a static memory 606, some or all of which may communicate with each other via an interlink (e.g., bus) 608. Examples of main memory 604 may include Synchronous Dynamic Random-Access Memory (SDRAM), such as Double Data Rate memory, such as DDR4 or DDR5. Interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 624 may further be transmitted or received over a communications network 626 using a transmission medium via the network interface device 620. The Machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

What is claimed is:

1. A computing device for secure booting of a layered software architecture, comprising:
a hardware processor;
a memory, storing a plurality of software layers, each of the plurality of software layers configured to perform operations comprising:
generate a cryptographic key derived from an accumulated device identifier of a current layer during boot-up and a measurement of a next software layer of the plurality of software layers, wherein the accumulated device identifier is created by an accumulation of a unique device secret and measurements of the current layer's code and measurements of code of each of the preceding ones of the plurality of layers;
decrypt a stored encrypted parameter of the next software layer of the plurality of software layers using the generated cryptographic key to produce a decrypted parameter; and
boot the next software layer using the decrypted parameter, the next software layer not loading or terminating if the decrypted parameter is not a correct parameter for the next software layer.

2. The computing device of claim 1, wherein the cryptographic key is one of: a symmetric key or an asymmetric key.

3. The computing device of claim 1, wherein the stored encrypted parameter includes an initialization function for the next software layer.

4. The computing device of claim 1, wherein the stored encrypted parameter includes a cryptographic key for the next software layer.

5. The computing device of claim 1, wherein the stored encrypted parameter includes configuration data for the next software layer.

6. The computing device of claim 1, wherein the decrypted parameter is passed to the next software layer, the next software layer configured to:
compare the decrypted parameter against an expected value; and
terminate execution of the next software layer based upon determining that the decrypted parameter does not match the expected value.

7. The computing device of claim 1, wherein the measurement of the current layer's code is a cryptographic hash of the code.

8. A method for secure booting of a layered software architecture, the method comprising: using one or more computer processors, executing a plurality of software layers, each of the plurality of software layers:
generating a cryptographic key derived from an accumulated device identifier of a current layer during boot-up and a measurement of a next software layer of the plurality of software layers, wherein the accumulated device identifier is created by an accumulation of a unique device secret and measurements of the current layer's code and measurements of code of each of the preceding ones of the plurality of layers;
decrypting a stored encrypted parameter of a next software layer of the plurality of software layers using the generated cryptographic key to produce a decrypted parameter; and
booting the next software layer using the decrypted parameter, the next software layer not loading or terminating if the decrypted parameter is not a correct parameter for the next software layer.

9. The method of claim 8, wherein the cryptographic key is one of: a symmetric key or an asymmetric key.

10. The method of claim 8, wherein the stored encrypted parameter includes an initialization function for the next software layer.

11. The method of claim 8, wherein the stored encrypted parameter includes a cryptographic key for the next software layer.

12. The method of claim 8, wherein the stored encrypted parameter includes configuration data for the next software layer.

13. The method of claim 8, wherein the decrypted parameter is passed to the next software layer, the next software layer configured to:
compare the decrypted parameter against an expected value; and
terminate execution of the next software layer based upon determining that the decrypted parameter does not match the expected value.

14. The method of claim 8, wherein the measurement of the current layer's code is a cryptographic hash of the code.

15. A machine-readable medium, storing instructions of a plurality of software layers for secure booting of a layered software architecture, the instructions, which when executed, cause the machine to perform operations comprising:
generating a cryptographic key derived from an accumulated device identifier of a current layer during boot-up and a measurement of a next software layer of the plurality of software layers, wherein the accumulated device identifier is created by an accumulation of a unique device secret and measurements of the current layer's code and measurements of code of each of the preceding ones of the plurality of layers;
decrypting a stored encrypted parameter of a next software layer of the plurality of software layers using the generated cryptographic key to produce a decrypted parameter; and
booting the next software layer using the decrypted parameter, the next software layer not loading or terminating if the decrypted parameter is not a correct parameter for the next software layer.

16. The machine-readable medium of claim 15, wherein the cryptographic key is one of: a symmetric key or an asymmetric key.

17. The machine-readable medium of claim 15, wherein the stored encrypted parameter includes an initialization function for the next software layer.

18. The machine-readable medium of claim 15, wherein the stored encrypted parameter includes a cryptographic key for the next software layer.

19. The machine-readable medium of claim 15, wherein the stored encrypted parameter includes configuration data for the next software layer.

20. The machine-readable medium of claim 15, wherein the decrypted parameter is passed to the next software layer, the next software layer configured to:
compare the decrypted parameter against an expected value; and
terminate execution of the next software layer based upon determining that the decrypted parameter does not match the expected value.

21. The machine-readable medium of claim 15, wherein the measurement of the current layer's code is a cryptographic hash of the code.
